(19) United States
(12) Patent Application Publication
(10) Pub. No.: US 2008/0053801 A1
(43) Pub. Date: Mar. 6, 2008

(54) DRIVE UNIT

(75) Inventor: Franz-Josef Korber, Altenstadt (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/847,809

(22) Filed: Aug. 30, 2007

(30) Foreign Application Priority Data
Sep. 2, 2006 (DE) 10 2006 041 250.8

(51) Int. Cl. H01H 7/00

(52) U.S. Cl. 200/33 R

(57) ABSTRACT

The disclosure relates to a drive unit for a circuit breaker, which comprises a drive for actuating the circuit breaker and a position signalling device for detecting the ON position of the circuit breaker, the drive actuating the position signalling device by means of a mechanical gear mechanism. The gear mechanism comprises at least one spring element, which is arranged in the motion transfer chain between the drive and the position signalling device in such a way that the spring element experiences elastic deformation when the circuit breaker closes.

### RELATED APPLICATIONS

This application claims priority under 35 U.S.C. §119 to German Application 10 2006 041 250.8 filed in Germany on Sep. 2, 2006, the entire contents of which are hereby incorporated by reference in their entireties.

### TECHNICAL FIELD

The disclosure relates to a drive unit for a circuit breaker, e.g., for a high-voltage circuit breaker.

### BACKGROUND INFORMATION

A drive unit for a high-voltage circuit breaker comprises, for example, a drive, as is known from EP 0829 892 A1. Such a drive for a high-voltage circuit breaker comprises a hydraulic system, which acts on a drive rod. The drive rod actuates the circuit breaker.

The drive unit furthermore comprises at least one position signalling device for detecting the position of the circuit breaker, in particular for detecting the ON position. The drive actuates the position signalling device by means of a mechanical gear mechanism, which is in the form of a lever mechanism, for example.

Testing a circuit breaker after manufacture and when it is first used includes comparatively rapidly running through a closing and opening operation, referred to below as an ON-OFF cycle. In this case, the open circuit breaker is first closed by the drive unit, i.e. moved from the OFF position into the ON position. When the ON position is reached, which is indicated by the position signalling device, the drive unit opens the circuit breaker again without a delay, i.e. moves it from the ON position back to the OFF position.

Known drive units require less than 30 ms for such an ON-OFF cycle. This time span is too short for many circuit breakers; mechanically moving parts and the contacts of the circuit breaker are subject to increased wear during this relatively rapid movement.

In the event of a circuit breaker being switched on in response to a short circuit, a relatively high direct current component is still available at the time of arc quenching in the case of very rapidly occurring switching-off, which relatively high direct current component decays with time. This direct current component additionally loads the contacts of the circuit breaker.

In the case of SF6 circuit breakers, there is the risk in the event of excessively rapid switching-off after switching-on has taken place that the blowing volume has not yet been completely filled and therefore too little SF6 gas is available for blowing the arc.

### SUMMARY

The disclosure is based on the object of specifying a drive unit in which the duration of an ON-OFF cycle is extended.

According to the disclosure, the gear mechanism of the drive unit, by means of which the drive actuates the position signalling device for detecting the ON position of the circuit breaker, comprises at least one spring element, which is arranged in the motion transfer chain between the drive and the position signalling device in such a way that the spring element experiences elastic deformation when the circuit breaker closes.

The motion transfer chain between the drive and the position signalling device in this case comprises the parts of the gear mechanism which transfer the motion of the drive as far as the position signalling device.

If the drive of the drive unit according to the disclosure closes the circuit breaker, the gear mechanism transfers the motion of the drive along the described motion transfer chain initially to the spring element. The spring element absorbs the transferred motion and is deformed elastically. Then, i.e. with a time delay, back-deformation of the spring element into its initial state takes place. In this case, the spring element transfers the absorbed motion further along the described motion transfer chain as far as the position signalling device.

While the spring element assumes its original shape again with a time delay, the position signalling device is actuated. Only now is the ON position of the circuit breaker identified and the drive unit can open the circuit breaker again. The gear mechanism therefore transfers the motion of the drive with a time delay to the position signalling device.

Owing to the resultant extension of the time span before the ON position of the circuit breaker is identified, the duration of an ON-OFF cycle is extended.

In accordance with an advantageous configuration of the disclosure, the spring element is arranged outside of the motion transfer chain between the drive and the circuit breaker. The motion transfer chain between the drive and the circuit breaker in this case comprises the parts of the gear mechanism which transfer the motion of the drive as far as the circuit breaker.

Owing to this arrangement of the spring element, only the time span until identification of the ON position of the circuit breaker is extended, but the circuit breaker itself is actuated without any delay.

In accordance with a possible configuration of the disclosure, the spring element is in the form of a helical spring.

The use of a helical spring is a solution which is relatively simple to realize.

In accordance with a further possible configuration of the disclosure, the spring element is in the form of a torsion bar.

The use of a torsion bar is likewise a solution which is relatively simple to realize.

In accordance with an alternative configuration of the disclosure, the spring element is in the form of an elastically deformable lever.

This also represents a solution which is relatively simple to realize.

In accordance with an advantageous development of the disclosure, the gear mechanism comprises a damping element.

By means of a damping element, the time span until identification of the ON position of the circuit breaker can be extended and adjusted further.

### BRIEF DESCRIPTION OF THE DRAWINGS

The disclosure, advantageous configurations and improvements of the disclosure and further advantages will be explained and described in more detail with reference to the drawings, in which exemplary embodiments of the disclosure are illustrated and in which:

FIG. 1 shows a first exemplary embodiment of a drive unit according to the disclosure with the circuit breaker open,

FIG. 2 shows the drive unit shown in FIG. 1 directly after closing of the circuit breaker,

FIG. 3 shows the drive unit shown in FIG. 1 with the circuit breaker closed,

FIG. 4 shows a second exemplary embodiment of a drive unit according to the disclosure with the circuit breaker open,

FIG. 5 shows the drive unit shown in FIG. 4 directly after closing of the circuit breaker,

FIG. 6 shows the drive unit shown in FIG. 4 with the circuit breaker closed,

FIG. 7 shows a third exemplary embodiment of a drive unit according to the disclosure,

FIG. 8 shows an exemplary hydraulic damping system for a drive unit according to the disclosure, and

FIG. 9 shows an exemplary drive unit having a plurality of position signalling devices.

### DETAILED DESCRIPTION

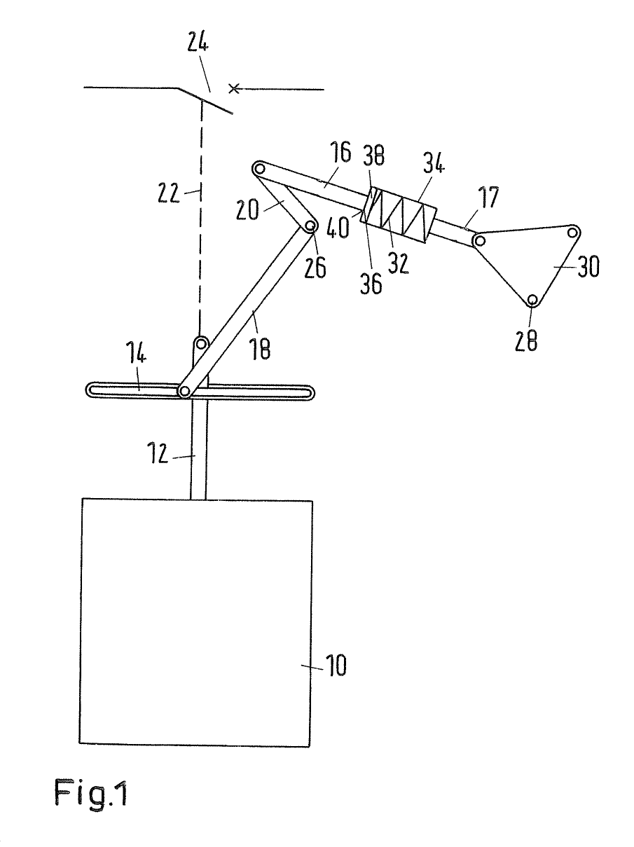

FIG. 1 illustrates a first exemplary embodiment of a drive unit according to the disclosure with the circuit breaker open. A drive 10 actuates a circuit breaker 24, which is illustrated schematically, via a drive rod 12 capable of translatory motion and via a likewise schematically illustrated line of action 22. In the illustration shown, the circuit breaker 24 is open and the drive rod 12 is located in a first end position.

The drive 10 is a hydraulic spring-loaded drive. Other types of drive are also conceivable, however.

The circuit breaker 24 is a high-voltage circuit breaker for voltages of from 100 kV to 400 kV. However, the circuit breaker 24 can likewise be a medium-voltage circuit breaker for voltages of from 1 kV to 100 kV or a low-voltage circuit breaker for voltages of less than 1 kV or a high-voltage circuit breaker for voltages of greater than 400 kV.

At right angles to its direction of motion, a guide rail 14 is fitted to the drive rod 12. A first drive lever 18 is fastened at one end to a stationary lever shaft 26, which is mounted such that it can rotate. Its other end is mounted displaceably in the guide rail 14. A second drive lever 20 is likewise fastened at one end to the lever shaft 26. The first drive lever 18 and the second drive lever 20 are rigidly coupled to one another via the lever shaft 26, i.e. they always rotate together with lever shaft 26 about its axis of rotation.

A first position signalling device lever 30 is fastened at one end to a stationary, first position signalling device shaft 28, which is mounted such that it can rotate. The first position signalling device shaft 28 actuates a position signalling device (not illustrated here), which senses the position of the first position signalling device shaft 28 and, from this, detects the position of the circuit breaker 24, in this example the OFF position. That end of the first position signalling device lever 30 which is remote from the first position signalling device shaft 28 is connected to that end of the second drive lever 20 which is remote from the lever shaft 26 by a first connecting bolt 16 and a second connecting bolt 17.

A pressure plate 38 is fitted at that end of the first connecting bolt 16 which is remote from the second drive lever 20. A spring encapsulation 34 is fitted at that end of the second connecting bolt 17 which is remote from the first position signalling device lever 30. The spring encapsulation 34 has, on the first front side 36 which is remote from the first position signalling device lever 30, an opening 40, through which the first connecting bolt 16 protrudes into the spring encapsulation 34. The pressure plate 38 is therefore arranged in the interior of the spring encapsulation 34.

The first connecting bolt 16 and the second connecting bolt 17 are arranged such that their longitudinal axes coincide. The spring encapsulation 34 in this case acts as a linear guide for the first connecting bolt 16 and the pressure plate 38. The first connecting bolt 16 can therefore carry out a translatory motion in relation to the second connecting bolt 17 along their common longitudinal axis.

A first helical spring 32 is arranged in the spring encapsulation 34 such that the pressure plate 38 is compressed if the first connecting bolt 16 moves towards the second connecting bolt 17. If the first connecting bolt 16 moves away from the second connecting bolt 17, the pressure plate 38 acts on the first front side 36 of the spring encapsulation 34 without affecting the first helical spring 32.

The drive rod 12, the guide rails 14, the first connecting bolt 16 with the pressure plate 38, the second connecting plate 17 with the spring encapsulation 34, the first drive lever 18, the second drive lever 20, the lever shaft 26, the first position signalling device shaft 28, the first position signalling device lever 30 and the first helical spring 32 are parts of a mechanical gear mechanism, namely a lever mechanism, by means of which the drive 10 actuates the position signalling device.

The first helical spring 32 in this gear mechanism represents the spring element which is arranged in the motion transfer chain between the drive 10 and the position signalling device. The first helical spring 32 is in this example arranged outside of the motion transfer chain between the drive 10 and the circuit breaker 24.

In the illustration shown here, the circuit breaker 24 is open, and the position signalling device detects the OFF position of the circuit breaker 24. The pressure plate 38 touches the first front side 36 of the spring encapsulation 34, and the first helical spring 32 is largely relieved of tension.

The first helical spring 32 is in this case illustrated as being cylindrical, but it may also be conical, for example. Instead of a helical spring 32, it is also conceivable to use a disc spring or a set of disc springs. The use of a gas compression spring is also conceivable.

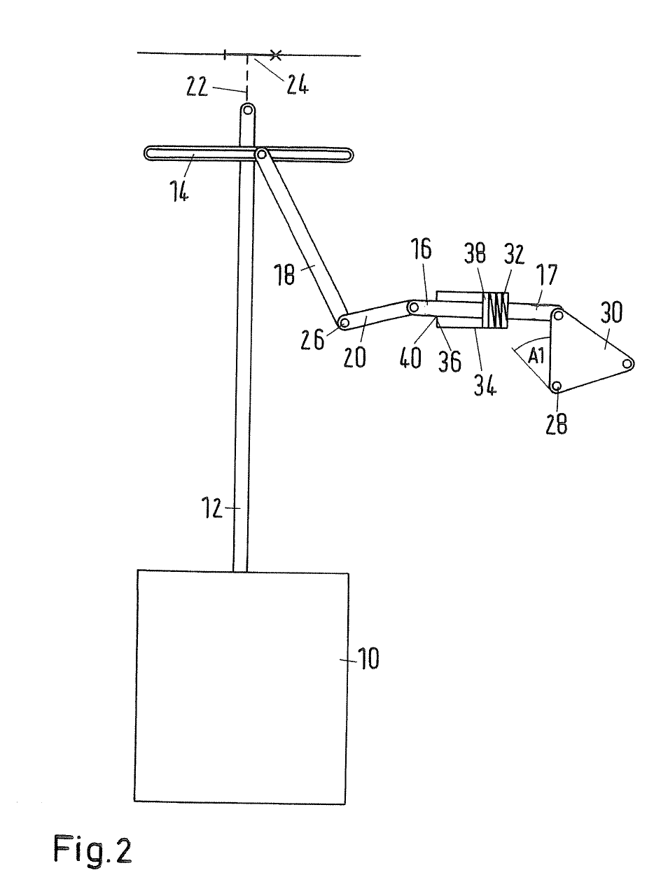

FIG. 2 illustrates the drive unit shown in FIG. 1 directly after closing of the circuit breaker 24. In relation to FIG. 1, the drive 10 has actuated the drive rod 12 and closed the circuit breaker 24. The first drive lever 18 and the second drive lever 20 have rotated about the lever shaft 26 and moved the first connecting bolt 16 with the pressure plate 38 towards the second connecting bolt 17.

In this case, the pressure plate 38 has compressed the first helical spring 32. The first position signalling device lever 30 and the first position signalling device shaft 28 have rotated through the first rotary angle A1 about the axis of rotation of the first position signalling device shaft 28.

From the position illustrated here of the first position signalling device shaft 28, the position signalling device detects the OFF position or an intermediate position of the circuit breaker 24. In this case, an intermediate position of the circuit breaker 24 is understood to mean a position in which the circuit breaker 24 assumes neither the OFF position nor the ON position.

In the illustration shown here, the circuit breaker 24 is therefore closed, but the position signalling device detects the OFF position or an intermediate position instead of the ON position of the circuit breaker 24. The first helical spring 32 is compressed by the pressure plate 38 within the spring encapsulation 34.

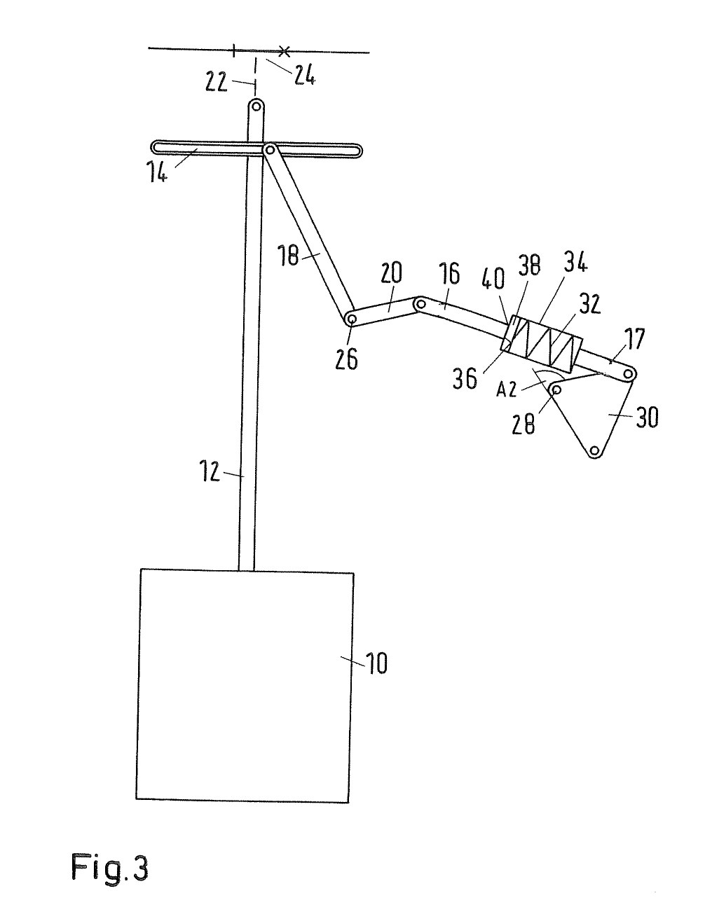

FIG. 3 shows the drive unit shown in FIG. 1 with the circuit breaker closed. The drive rod 12, the guide rail 14, the first drive lever 18, the second drive lever 20 and the lever shaft 26 are each in the same position as illustrated in FIG. 2.

The first position signalling device lever 30 and the first position signalling device shaft 28 have rotated, in relation to the illustration shown in FIG. 1, through the second rotary angle A2 about the axis of rotation of the first position signalling device shaft 28, the first rotary angle A1 being smaller than the second rotary angle A2.

From the position illustrated here of the first position signalling device shaft 28, the position signalling device detects the ON position of the circuit breaker 24. Similarly to as in the illustration shown in FIG. 1, the first helical spring 32 is largely relieved of tension, and the pressure plate 38 bears against the first front side 36 of the spring encapsulation 34.

In the illustration shown here, the circuit breaker 24 is therefore closed, and the position signalling device detects the ON position of the circuit breaker 24. The pressure plate 38 touches the first front side 36 of the spring encapsulation 34, and the first helical spring 32 is relieved of tension.

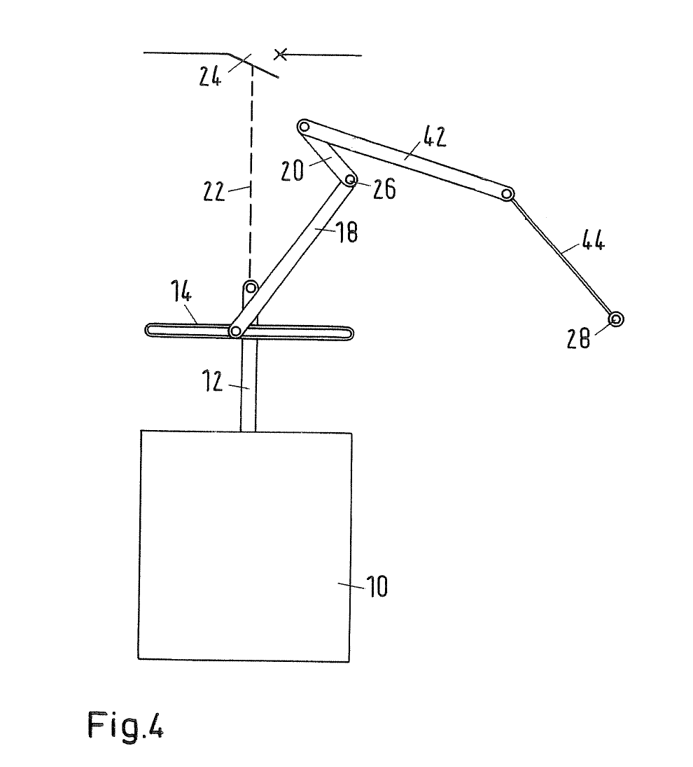

FIG. 4 illustrates a second exemplary embodiment of a drive unit according to the disclosure, which is similar to the drive unit shown in FIG. 1. In the text which follows, details will be given on the differences from the drive unit shown in FIG. 1.

Instead of the first connecting bolt 16, the second connecting bolt 17, the spring encapsulation 34, the first helical spring 32 and the pressure plate 38, a third connecting bolt 42 is provided which is connected with one end to the second drive lever 20. Instead of the first position signalling device lever 30, a flexible position signalling device lever 44 is provided which is fastened with one end to the stationary first position signalling device shaft 28.

That end of the third connecting bolt 42 which is opposite the drive lever 20 is connected to that end of the flexible position signalling device lever 44 which is opposite the first position signalling device shaft 28.

The flexible position signalling device lever 44 is in this case designed such that it is deformable exclusively in a predetermined direction, which is at right angles to its longitudinal axis and at right angles to the longitudinal axis of the position signalling device shaft 28.

In the illustration shown here, the circuit breaker 24 is open, and the position signalling device detects the OFF position of the circuit breaker 24. The flexible position signalling device lever 44 has not been deformed.

Instead of the flexible position signalling device lever 44, it is also conceivable to use a leaf spring.

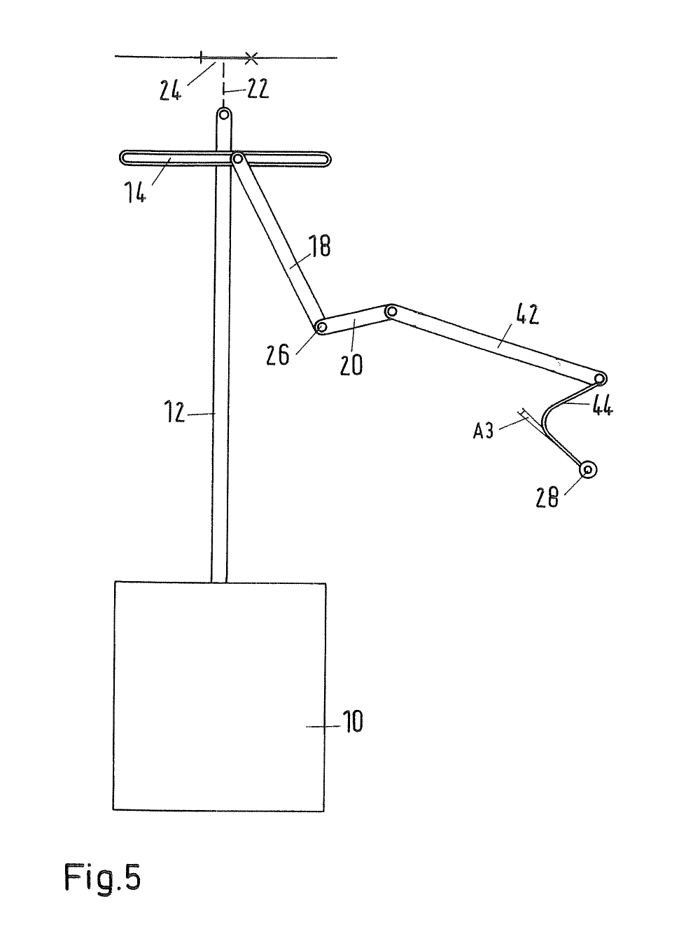

FIG. 5 illustrates the drive unit shown in FIG. 4 directly after closing of the circuit breaker 24. In relation to FIG. 4, the drive 10 has actuated the drive rod 12 and closed the circuit breaker 24. The first drive lever 18 and the second drive lever 20 have rotated about the lever shaft 26, and the third connecting bolt 42 exerts a force on the flexible position signalling device lever 44.

The flexible position signalling device lever 44 has been deformed in the predetermined direction and, in the process, has absorbed deformation energy. The first position signalling device shaft 28 has rotated through the third rotary angle A3 about the axis of rotation of the first position signalling device shaft 28.

In the illustration shown here, the circuit breaker 24 is therefore closed, but the position signalling device detects the OFF position or an intermediate position instead of the ON position of the circuit breaker 24. The flexible position signalling device lever 44 has been deformed.

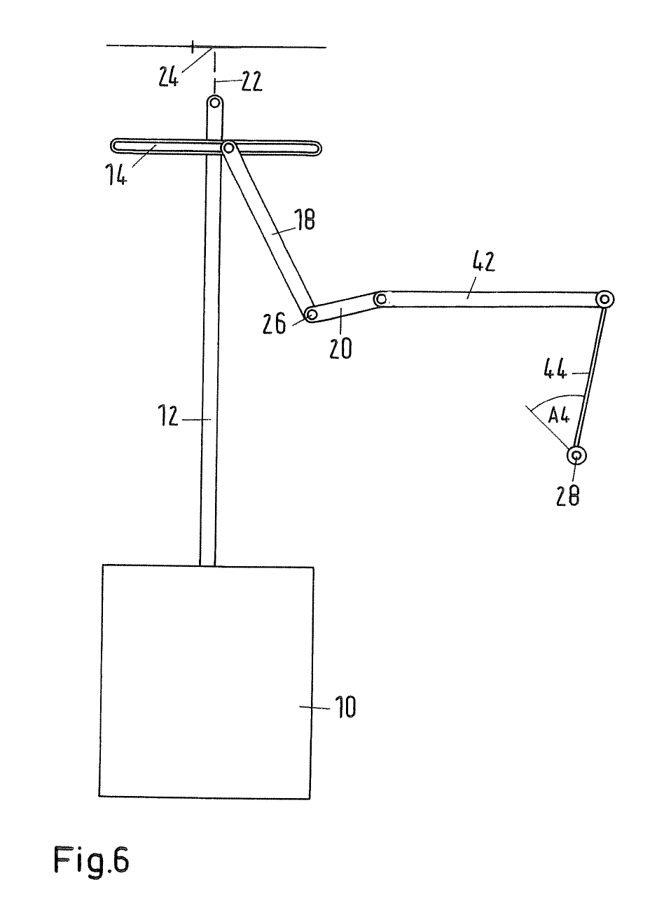

FIG. 6 shows the drive unit shown in FIG. 4 with the circuit breaker closed. The drive rod 12, the guide rail 14, the first drive lever 18, the second drive lever 20 and the lever shaft 26 are each in the same position as illustrated in FIG. 5. The flexible position signalling device lever 44 has output the absorbed deformation energy to the drive shaft 28 and has been deformed back.

The first position signalling device shaft 26 has rotated, in relation to the illustration shown in FIG. 4, through the fourth rotary angle A4 about the axis of rotation of the first position signalling device shaft 28, the third rotary angle A3 being smaller than the fourth rotary angle A4.

In the illustration shown here, the circuit breaker 24 is therefore closed, and the position signalling device detects the ON position of the circuit breaker 24. The flexible position signalling device lever 44 has not been deformed.

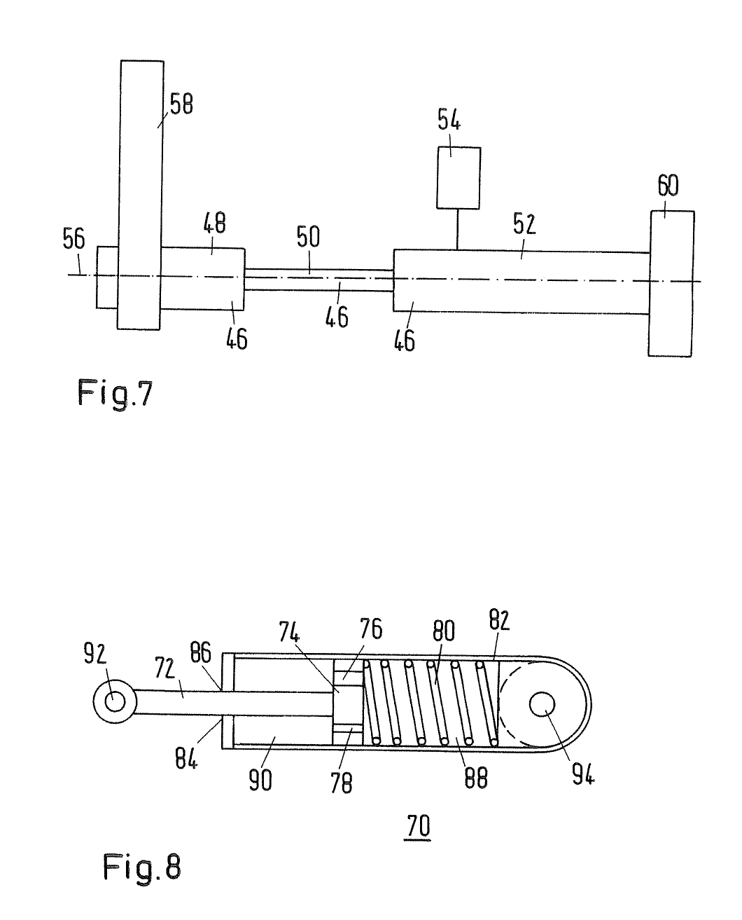

FIG. 7 illustrates a third exemplary embodiment of a drive unit according to the disclosure. The drive 10 moves a fixed position signalling device lever 58 via a mechanical lever mechanism (not illustrated here). The position signalling device lever 58 is fastened to a twistable position signalling device shaft 46, which is mounted such that it can rotate about its longitudinal axis 56. A position signalling device 54 senses the position of the twistable position signalling device shaft 46 and detects from this the position of the circuit breaker 24.

The twistable position signalling device shaft 46 has a first part 48, to which the fixed position signalling device lever 58 is fastened, and a third part 52, whose position is sensed by the position signalling device 54. The first part 48 and the third part 52 of the twistable position signalling device shaft 46 are in this case rigid, i.e. torsion of the first part 48 or the third part 52 about the longitudinal axis 56 is not possible.

The twistable position signalling device shaft 46 has a second part 50, which can twist elastically about the longitudinal axis 56 of the twistable position signalling device shaft 46, between the first part 48 and the third part 52. The second part 50 in this arrangement acts as a torsion bar. That is to say the first part 48 can be rotated with respect to the third part 52 of the twistable position signalling device shaft 46.

In order to close the circuit breaker 24, the drive 10 moves the fixed position signalling device lever 58 via the mechanical gear mechanism. In this case, the fixed position signalling device lever 58 is rotated together with the first part 48 of the twistable position signalling device shaft 46 about its longitudinal axis 56. The second part 50 of the twistable position signalling device shaft 46 in the process experiences a rotation about the longitudinal axis 56. The third part 52 of the twistable position signalling device shaft 46 follows the rotation of the first part 48 with a time delay. The position signalling device 54, which senses the position of the third part 52 of the twistable position signalling device shaft 46, detects the ON position of the circuit breaker 24, likewise with a time delay.

In addition, a damping mass 60, which increases the moment of inertia of the third part 52 of the twistable position signalling device shaft 46, is fitted to the third part 52 of the twistable position signalling device 46. In the event of a rotation of the first part 48 of the twistable position signalling device shaft 46, the third part 52 follows this rotation with an increased time delay in comparison with an arrangement without a damping mass 60. The time delay can be adjusted by means of the damping mass 60. This means that the greater the moment of inertia of the third part 52 and the damping mass 60 is, the greater the time delay also is.

In the drive unit shown in FIG. 7, the drive 10 drives the twistable position signalling device shaft 46 by means of a lever mechanism. It is also conceivable that another type of gear mechanism, for example a toothed belt drive, is used instead of the lever mechanism. In this case, a pulley is fastened to the flexible position signalling device shaft 46 instead of the fixed position signalling device lever 58, which pulley can be driven by means of a toothed belt.

It is also conceivable to attach a damping mass 60 to the first position signalling device shaft 28 of a drive unit as shown in FIG. 1 or FIG. 4. This increases the moment of inertia of the position signalling device shaft 28 and further extends the time span until identification of the ON position of the circuit breaker 24 by means of the position signalling device 54. In this case, too, the time delay can be adjusted by means of the moment of inertia of the damping mass 60.

It is furthermore conceivable to use a helical spring or a torsion spring instead of the second part 50, which acts as a torsion rod.

FIG. 8 illustrates an exemplary hydraulic damping system 70 for a drive unit according to the disclosure. A cylinder 82 has a drilled hole 86 on a second front side 84, through which drilled hole a piston rod 72 protrudes into the interior of the cylinder 82. A piston 74 is fastened to that end of the piston rod 72 which is located in the interior of the cylinder 82. In addition, a second helical spring 80, which presses onto the piston 74, is provided in the interior of the cylinder 82.

A first fastening point 92 is provided at that end of the piston rod 72 which is opposite the piston 74, and a second fastening point 94 is provided at that end of the cylinder 82 which is opposite the second front side 84. The hydraulic damping system 70 can be integrated in a lever mechanism by means of the fastening points 92 and 94.

The interior of the cylinder 82 is filled with a liquid, for example a hydraulic oil. The piston 74 divides the interior of the cylinder 82 into a spring area 88 and a cavity 90. The cavity 90 is the region of the cylinder 82 between the second front side 84 and the piston 74. The spring area 88 is located on that side of the piston 74 which is remote from the second front side 84 and accommodates the second helical spring 80.

The piston 74 has an aperture 78, through which the liquid in the interior of the cylinder 82 can flow from the spring area 88 into the cavity 90 and in the reverse direction. The cross section of the aperture 78 can be adjusted variably. In addition, the piston 74 has a nonreturn valve 76, which is arranged such that liquid can flow from the spring area 88 into the cavity 90, but not in the reverse direction.

The hydraulic damping system 70 can be integrated, for example, in a drive unit similar to that shown in FIG. 1. The hydraulic damping system 70 in this case replaces the first connecting bolt 16 with the pressure plate 38 and the second connecting bolt 17 with the spring encapsulation 34 and the first helical spring 32. The first fastening point 92 is in this case fastened at the free end of the second drive lever 20, and the second fastening point 94 is fastened at a free end of the first position signalling device lever 30.

When the circuit breaker 24 is open, the piston 74 touches the second front side 84 of the cylinder 82, and the second helical spring 80 is relieved of tension. The position signalling device detects the OFF position of the circuit breaker 24. The liquid in the interior of the cylinder 82 is located completely in the spring area 88. The volume of the cavity 90 becomes zero.

Directly after closing of the circuit breaker 24 by means of the drive 10, the hydraulic damping system 70 assumes the position shown in FIG. 8. The piston 74 has moved away from the second front side 84 of the cylinder 82 and compressed the second helical spring 80. The nonreturn valve 76 is open and makes it possible for liquid to flow from the spring area 88, through the nonreturn valve 76, into the cavity 90. Likewise, the liquid flows through the aperture 78 from the spring area 88 into the cavity 90. The degree to which the volume of the spring area 88 is reduced is also the degree to which the volume of the cavity 90 is increased.

The circuit breaker 24 is closed in this state, but the position signalling device still detects the OFF position or an intermediate position.

Then, the spring 80 presses onto the piston 74 and moves it towards the second front side 84 of the cylinder 82. In this case, the nonreturn valve 76 is closed, and the liquid merely flows through the aperture 78 from the cavity 90 into the spring area 88. The degree to which the volume of the spring area 88 is increased is also the degree to which the volume of the cavity 90 is reduced. This motion is damped by virtue of the fact that the liquid can only flow through the comparatively small cross section of the aperture 78.

The speed at which this motion takes place can be adjusted by the aperture 78. The smaller the cross section of the aperture 78 is, the slower the motion of the piston 74 towards the second front side 84 of the cylinder 82 is.

If the liquid flows almost completely back into the spring area 88, the piston 74 again touches the second front side 84 of the cylinder 82, and the second helical spring 80 is relieved of tension. The position signalling device detects the ON position of the circuit breaker 24. The liquid in the interior of the cylinder 82 is located completely in the spring area 88, and the volume of the cavity 90 becomes zero.

The second helical spring 80 is in this case illustrated as being cylindrical, but it may also be conical, for example. Instead of a helical spring 80, it is also conceivable to use a disc spring or a set of disc springs. The use of a gas compression spring is also conceivable.

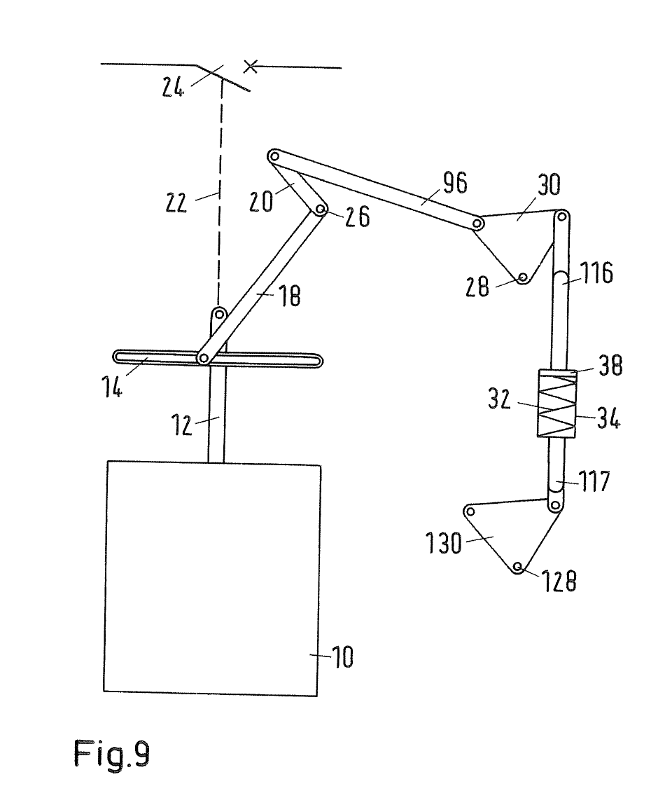

FIG. 9 illustrates a drive unit having a plurality of position signalling devices. The drive unit comprises a first position signalling device (not illustrated here) and a second position signalling device (likewise not illustrated). For example, the first position signalling device is used for detecting the OFF position, and the second position signalling device is used for detecting the ON position of the circuit breaker.

Similarly to the drive unit illustrated in FIG. 1, the drive unit shown in FIG. 9 comprises a drive 10 for actuating a circuit breaker 24, a drive rod 12, a guide rail 14, a first drive lever 18, a second drive lever 20, a lever shaft 26, a first position signalling device lever 30 and a first position signalling device shaft 28. A rigid fourth connecting bolt 96 is fitted between the first position signalling device lever 30 and the second drive lever 20. The first position signalling device senses the position of the first position signalling device shaft 28.

The second position signalling device senses the position of a second position signalling device shaft 128. A second position signalling device lever 130 is fastened with one end to the second position signalling device shaft 128.

An end of the first position signalling device lever 30 which is remote from the position signalling device shaft 28 is connected to that end of the second position signalling device lever 130 which is remote from the second position signalling device shaft 128 by means of a fifth connecting bolt 116 and a sixth connecting bolt 117.

A spring encapsulation 34 is fitted at that end of the sixth connecting bolt 117 which is remote from the second position signalling device lever 130. A pressure plate 38 is fitted at that end of the fifth connecting bolt 116 which is remote from the first position signalling device lever 30. The fifth connecting bolt 116 protrudes into the spring encapsulation 34, with the result that the pressure plate 38 is located in the interior of the spring encapsulation 34 and presses onto a first helical spring 32.

In the illustration shown, the circuit breaker 24 is open, and the first position signalling device detects the OFF position of the circuit breaker 24. The second position signalling device detects that the circuit breaker 24 is not located in the ON position.

If the drive 10 now closes the circuit breaker 24, the first position signalling device shaft 28 is rotated without any delay, and the first position signalling device detects that the circuit breaker 24 is not located in the OFF position. The second position signalling device shaft 128 is rotated with a time delay, however, and the second position signalling device detects the ON position of the circuit breaker 24, with a time delay.

In the drive unit shown in FIG. 9, the first position signalling device for detecting the OFF position of the circuit breaker 24 is therefore always actuated without any delay, and the second position signalling device for detecting the ON position of the circuit breaker 24 experiences a delay during closing of the circuit breaker 24.

A hydraulic damping system 70, for example, can also be integrated in a drive unit having a plurality of position signalling devices, instead of the fifth connecting bolt 116 with the pressure plate 38 and the sixth connecting bolt 117 with the spring encapsulation 34 and the first helical spring 32.

It is also conceivable to configure the first position signalling device and the second position signalling device in such a way that both position signalling devices each sense the OFF position of the circuit breaker 24 and the ON position of the circuit breaker 24. Such an arrangement provides the possibility of always reading the actual position of the circuit breaker 24 from the first position signalling device, whilst it is possible to read the ON position of the circuit breaker 24 with a time delay from the second position signalling device.

In known drive units, a position signalling device for detecting the ON position of the circuit breaker is often integrated in the circuit for driving the tripping coil for switching the circuit breaker off in such a way that this circuit can only be closed if the position signalling device for detecting the ON position detects the ON position of the circuit breaker. With this design, said tripping coil can only be driven if the position signalling device for detecting the ON position has detected, with a time delay, the ON position of the circuit breaker.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

| | |
|---|---|
| 10 | Drive |
| 12 | Drive rod |
| 14 | Guide rail |
| 16 | First connecting |
| | bolt |
| 17 | Second connecting bolt |
| 18 | First drive lever |
| 20 | Second drive lever |
| 22 | Line of action |
| 24 | Circuit breaker |
| 26 | Lever shaft |
| 28 | First position |
| | signalling device |
| | shaft |
| 30 | First position |
| | signalling device |
| | lever |
| 32 | First helical |
| | spring |
| 34 | Spring |
| | encapsulation |
| 36 | First front side |
| 38 | Pressure plate |
| 40 | Opening |
| 42 | Third connecting |
| | bolt |
| 44 | Flexible position |
| | signalling device |
| | lever |
| 46 | Twistable position |
| | signalling device |
| | shaft |
| 48 | First part of the |
| | twistable position |
| | signalling device shaft |
| 50 | Second part of the |
| | twistable position |
| | signalling device |
| | shaft |
| 52 | Third part of the |
| | twistable position |
| | signalling device |
| | shaft |
| 54 | Position signalling |
| | device |
| 56 | Longitudinal axis |
| | of the twistable |
| | position signalling |
| | device shaft |
| 58 | Fixed position |
| | signalling device |
| | lever |
| 60 | Damping mass |
| 70 | Damping system |
| 72 | Piston rod |
| 74 | Piston |
| 76 | Nonreturn valve |
| 78 | Aperture |
| 80 | Second helical spring |
| 82 | Cylinder |
| 84 | Second front side |
| 86 | Drilled hole |
| 88 | Spring area |
| 90 | Cavity |
| 92 | First fastening point |
| 94 | Second fastening point |
| 96 | Fourth connecting bolt |
| 116 | Fifth connecting bolt |
| 117 | Sixth connecting bolt |
| 128 | Second position |
| | signalling device |
| | shaft |
| 130 | Second position |
| | signalling device |
| | lever |
| A1 | First rotary angle |
| A2 | Second rotary angle |
| A3 | Third rotary angle |
| A4 | Fourth rotary angle |

What is claimed is:

1. Drive unit for a circuit breaker, comprising a drive for actuating the circuit breaker and a position signalling device for detecting the ON position of the circuit breaker, the drive actuating the position signalling device by means of a mechanical gear mechanism, wherein
the gear mechanism comprises at least one spring element, which is arranged in the motion transfer chain between the drive and the position signalling device in such a way that the spring element experiences elastic deformation when the circuit breaker closes.

2. Drive unit according to claim 1, wherein the spring element is arranged outside of the motion transfer chain between the drive and the circuit breaker.

3. Drive unit according to claim 1, wherein the spring element is in the form of a helical spring.

4. Drive unit according to claim 1, wherein the spring element is in the form of a torsion bar.

5. Drive unit according to claim 1, wherein the spring element is in the form of an elastically deformable lever.

6. Drive unit according to claim 1, wherein the gear mechanism comprises at least one damping element.

7. Drive unit according to claim 6, wherein the damping element is in the form of a damping mass.

8. Drive unit according to claim 6, wherein the damping element is in the form of a hydraulic damping system, which comprises a piston and a cylinder.

9. Drive unit according to claim 1, wherein the circuit breaker is a high-voltage circuit breaker.

10. Drive unit according to claim 1, wherein the circuit breaker is a medium-voltage circuit breaker or a low-voltage circuit breaker.

11. Drive unit according to claim 2, wherein the spring element is in the form of a helical spring.

12. Drive unit according to claim 2, wherein the spring element is in the form of a torsion bar.

13. Drive unit according to claim 2, wherein the spring element is in the form of an elastically deformable lever.

14. Drive unit according to claim 5, wherein the gear mechanism comprises at least one damping element.

15. Drive unit according to claim 8, wherein the circuit breaker is a high-voltage circuit breaker.

16. Drive unit according to claim 9, wherein the circuit breaker is a medium-voltage circuit breaker or a low-voltage circuit breaker.

17. A drive unit for a circuit breaker, comprising:
a drive for actuating the circuit breaker;
a position signalling device for detecting the ON position of the circuit breaker; and
a mechanical gear mechanism having at least one spring element, wherein the drive actuates the position signalling device by using the mechanical gear mechanism.
